(19) United States
(12) Patent Application Publication
(10) Pub. No.: US 2009/0148667 A1
(43) Pub. Date: Jun. 11, 2009

(54) Method of manufacturing ceramic laminated substrate and ceramic laminated substrate manufactured using the same

(75) Inventors: Yong Seok Choi, Suwon (KR); Jong Myeon Lee, Gwacheon (KR); Eun Tae Park, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/314,205

(22) Filed: Dec. 5, 2008

(30) Foreign Application Priority Data
Dec. 7, 2007 (KR) 10-2007-0126756

(51) Int. Cl. B32B 3/10; B32B 38/00

(52) U.S. Cl. 428/166; 156/89.12

(57) ABSTRACT

There are provided a method of manufacturing a ceramic laminated substrate in which the ceramic laminated substrate, with a cavity formed therein, can be manufactured by constrained sintering without undergoing deformation of the cavity, and a ceramic laminated substrate manufactured using the same.

### CROSS-REFERENCE TO RELATED APPLICATIONS

This application claims the priority of Korean Patent Application No. 2007-0126756 filed on Dec. 7, 2007, in the Korean Intellectual Property Office, the disclosure of which is incorporated herein by reference.

### BACKGROUND OF THE INVENTION

1. Field of the Invention

The present invention relates to a method of manufacturing a ceramic laminated substrate and a ceramic laminated substrate manufactured using the same, and more particularly, a low temperature co-fired ceramic (LTCC).

2. Description of the Related Art

In general, a ceramic laminated substrate, particularly, a low temperature co-fired ceramic (LTCC) substrate is superior in thermal properties and permittivity, and miniaturizable, while capable of performing multifunctions, thus utilized in various technical fields.

The LTCC is fired at a low temperature of about 1000° C. or less. This LTCC process involves forming a via hole in a dielectric sheet having a thickness of about 40 to 80 um, filling, printing a conductive pattern, laminating, and co-firing.

For a slitting process, a low-temperature sinterable dielectric thick film having a predetermined thickness and width and in a rolled state is cut in a predetermined size according to an entire lamination number to thereby prepare a green sheet.

For a preconditioning process, the green sheet undergoes a preparatory stage of being heat-treated at a temperature of about 120° C. or maintained in a nitrogen atmosphere for predetermined hours.

As for processes of forming a via hole and filling, a via hole of an adequate size is formed in the green sheet using punching or laser, and the via hole is filled with a conductive paste. This conductive paste filled serves as a via electrode.

In the process of printing a conductive pattern, the conductive paste is formed into a desired circuit pattern by printing.

In a laminating process, green sheets are laminated and bonded to one another using a predetermined heat and pressure. In the case of a constrained LTCC process, a constraining layer is laminated on top and bottom surfaces of a laminated body of the green sheets.

Also, in a co-firing process, the laminated body which has undergone the laminating process is subjected to debinding at a temperature of 300 to 400° C. and sintered at a low temperature of 1000° C. or less.

After the sintering, the constraining layer is removed by lapping through a lapping machine or by using a sand blast or ultrasonic waves to obtain a ceramic laminated substrate.

The laminated substrate described above is usually modulized for use. In this modulization, parts of the ceramic laminated substrate having various materials, shapes and patterns should be guaranteed with a high degree of freedom in designing to achieve high precision.

That is, the parts with various materials, shapes and patterns can be embedded, arranged or connected freely with other internal circuits to ensure flexible designing. To this end, the parts should be positioned precisely in one-by-one correspondence with those of the designs and also the parts should be arbitrarily changed in location and size. That is, the parts should be assured of a high degree of freedom in designing.

One of technologies guaranteeing this degree of freedom is a cavity formation technology. A cavity is an opening recessed inward from an outermost surface of the substrate.

This cavity formation can lead to a need for a fewer number of important circuits and practically lowers a height of unit parts in the substrate, thereby advantageously bringing about compactness and thinness. Also, this enables applications in which when designing modules, various parts with heterogeneous materials can be joined together.

Meanwhile, the LTCC substrate includes a plurality of green sheets laminated and sintered at a low temperature of about 800° C. to 1000° C. The sintered substrate is shrunk considerably due to shrinkage of the green sheets during the sintering process.

To overcome this drawback, a constraining layer made of alumina is laminated on an outermost surface of a dielectric sheet by constrained sintering. This induces the green sheets laminated in the sintering process not to shrink in an x-y axis direction but to shrink only in a z axis direction, i.e., thickness direction.

However, in a case where the LTCC substrate described above is sintered by constrained sintering, the cavity formed in the laminated sheets does not undergo any constraint. This renders it hard to sinter the ceramic substrate, and during the sintering process, the cavity is deformed to hinder designing of the substrate.

### SUMMARY OF THE INVENTION

An aspect of the present invention provides a method of manufacturing a ceramic laminated substrate, in which the ceramic laminated substrate with a cavity formed therein can be manufactured by constrained sintering without undergoing deformation of the cavity, and a ceramic laminated substrate manufactured using the same.

According to an aspect of the present invention, there is provided a method of manufacturing a ceramic laminated substrate, the method including: laminating a sheet having a cavity therein on a ceramic laminated body; filling the cavity with a predetermined filler; and laminating and sintering a constraining body on at least one of a top of the sheet having the cavity therein and a bottom of the ceramic laminated body.

The filler may have a sintering temperature substantially equal to or higher than a sintering temperature of the constraining body.

The filler may include an alumina slurry.

The method may further include drying the filler, after the filling the cavity with a predetermined filler.

The method may further include removing the filler together with the constraining body, after the sintering.

The filling the cavity with a predetermined filler may include: laminating a screen having a throughhole formed in a position corresponding to the cavity on the sheet having the cavity therein.

According to another aspect of the present invention, there is provided a method of manufacturing a ceramic laminated substrate, the method including: laminating a sheet having a cavity therein on a ceramic laminated body; filling the cavity with a first constraining body; and laminating and sintering a second constraining body on at least one of a top of the sheet having the cavity therein and a bottom of the ceramic laminated body.

The method may further include removing the first and second constraining bodies after the sintering.

According to still another aspect of the present invention, there is provided a ceramic laminated substrate manufactured by the method defined above.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A to 1F schematically illustrate a method of manufacturing a ceramic multilayer substrate according to an exemplary embodiment of the invention.

### DETAILED DESCRIPTION OF THE PREFERRED EMBODIMENT

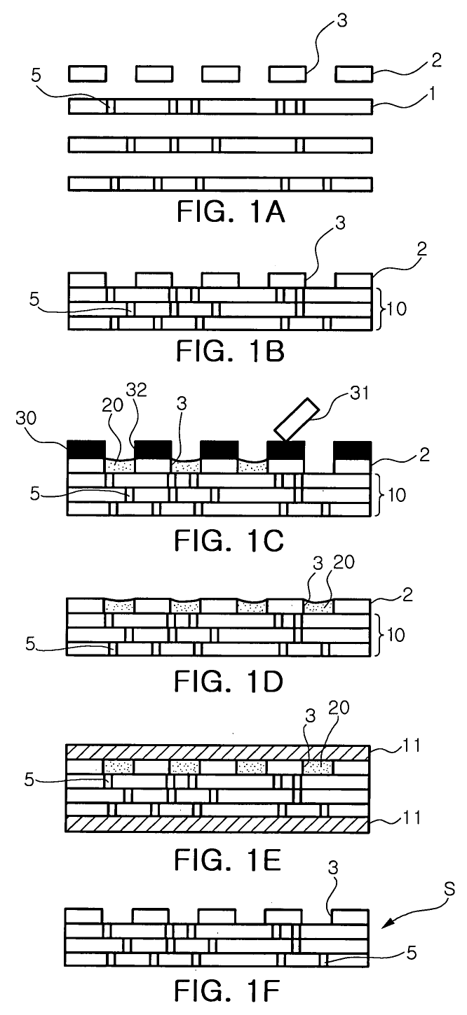

Exemplary embodiments of the present invention will now be described in detail with reference to the accompanying drawings. FIGS. 1A to 1F schematically illustrate a method of manufacturing a ceramic multilayer substrate according to an exemplary embodiment of the invention.

Hereinafter, the manufacturing method of the ceramic substrate according to the present embodiment will be described schematically.

Referring to a schematic illustration of FIG. 1A, ceramic laminated sheets 1 and a sheet 2 having cavities formed therein is provided.

Referring to a schematic illustration of FIG. 1B, the ceramic laminated sheets 1 and the sheet 2 provided in FIG. 1A are laminated.

As schematically illustrated in FIG. 1C, a filler 20 is filled in each of the cavities 3 of the sheet 2 laminated as shown in FIG. 1B.

Referring to a schematic illustration of FIG. 1D, the filler 20 filled in the cavity 3 in the process shown in FIG. 1C is dried.

Referring to a schematic illustration of FIG. 1E, constraining bodies 11 are laminated and sintered on a top and bottom of a laminated body of the laminated sheets which has been dried in the process shown in FIG. 1D.

Referring to a schematic illustration of FIG. 1F, the filler 20 together with the constraining bodies 11 is removed from the ceramic substrate sintered in the process shown in FIG. 1E.

The process of FIG. 1A will be described in more detail.

As shown in FIG. 1A, to manufacture a ceramic substrate according to the present embodiment, the plurality of ceramic laminated sheets 1 are provided.

To fabricate the plurality of the ceramic laminated sheets 1, a green sheet in an initially rolled state is slit into an appropriate size to form via holes therein and then each of the via holes is filled with a conductor paste to form an electrode 5.

Also, cavities 3 of an appropriate size are formed in a predetermined dielectric sheet by a method such as punching.

These cavities 3 are different from the via holes for forming the electrodes. The cavities 3 are formed to increase a degree of freedom in designing.

Therefore, each of the cavities 3 has a size determined by how the substrate will be designed. In a case where the cavity 3 is formed for mounting predetermined parts therein, the cavity 3 may be formed in a sufficient size to mount the parts therein.

Here, the sheet 2 having the cavity formed therein may be identical to each of the ceramic laminated sheets 1, but may contain components different from those of the ceramic laminated sheet 1. Here, the sheet 2 having the cavity therein may have a sintering temperature identical or at least similar to a sintering temperature of the ceramic laminated sheet 1.

The ceramic laminated sheet 1 is generally formed of glass-ceramics mainly composed of borosilicate glass and alumina.

The process of FIG. 1B will be described in more detail.

As shown in FIG. 1B, the plurality of ceramic laminated sheets 1 are laminated and the sheet 2 having the cavities 3 formed therein is laminated on a top of a laminated body 10 of the ceramic laminated sheets 1 and pressurized under a predetermined pressure to be bonded together.

At this time, the laminated sheets are not necessarily pressurized when formed into a laminated body, but pressurization may be performed after filling the filler 20 in the cavity 3 in the process of FIG. 1C.

Here, the ceramic laminated sheets 1 laminated atop one another, or laminated and pressurized under a predetermined pressure are referred to as a ceramic laminated body 10.

Referring to FIG. 1B, the sheet having the cavities 3 therein is illustrated to be formed on the top of the ceramic laminated body but the present invention is not limited thereto. The sheet having the cavities 3 therein may be laminated on a bottom of the ceramic laminated body 10, or on both the top and bottom of the ceramic laminated body.

Subsequently, the process of FIG. 1C will be described in more detail.

As shown in FIG. 1C, according to the manufacturing method of the ceramic substrate of the present embodiment, the filler 20 is filled in the each of the cavities 3.

Referring to FIG. 1C, the filler 20 is filled in the cavity 3 by screen printing. However, the present invention is not limited thereto. The filler 20 may be directly filled in the sheet 2 having the cavity therein without employing a screen.

In a case where the filler 20 is filled in the cavity 3 by printing using the screen 30, the screen 30 having a throughole 32 formed in an identical size to the cavity 3 is precisely laminated on the sheet 2 having the cavity 3 therein and then the filler 20 is printed on the screen 30 using a printing member 31.

The screen 30 may be employed in order to fill the filler 20 only in the cavity 3 without affecting other portions of the sheet 2.

Also, the filler 20 may be printed directly using the printing member 31 on the sheet 2 without employing the screen 30. This method may cause a residual of the filler 20 to remain in other portions of the sheet than the cavity 3.

The filler 20 may include an alumina slurry. The alumina slurry is made of components substantially identical to the constraining bodies which will be described later. This allows the alumina slurry to be joined to the constraining bodies superbly. This is because the alumina slurry has a sintering temperature substantially similar or identical to the constraining bodies.

Furthermore, in a case where the alumina slurry made of components substantially identical to the constraining bodies is utilized as the filler, the filler can be filled in the cavity 3 directly without employing the screen 30. Thus, any residual of the filler remaining on the sheet 2 does not significantly hamper the manufacture of the substrate since the constraining bodies with a similar composition are laminated in the process E of FIG. 1.

What is more, the filler 20 may adopt an identical material to the constraining body. That is, a first constraining body may be filled in the cavity 3 and a second constraining body may be laminated in the process of FIG. 1E.

Here, generally, the constraining bodies are formed of an inorganic powder and an organic binder and the inorganic powder utilizes an inorganic material such as alumina and zirconia, which is greatly different in the sintering temperature from glass-ceramics.

Afterwards, the process of FIG. 1D will be described in more detail.

As shown in FIG. 1D, after filling the filler 20 in the cavity 3, the filler 20 may be dried.

However, the filler 20 is not necessarily dried but may not be dried according to type of the filler.

In a case where the filler 20 is formed of a material similar or identical to the constraining bodies 11, the filler 20 may be dried in a similar fashion to the constraining bodies 11.

Thereafter, the process of FIG. 1E will be described in more detail.

After the filler 20 is filled in the cavity 3, or filled and dried in the process of FIG. 1C, the constraining bodies 11 are laminated.

After laminating the constraining bodies 11, a predetermined heat and pressure are applied to ensure smooth bonding between the ceramic laminated body 10 and a corresponding one of the constraining bodies 11 and between the sheet 2 having the cavity therein and the another corresponding constraining body 11. Here, the filler 20 filled in the cavity 3 is superbly bonded to the constraining bodies 11.

As described above, after the lamination of the constraining body 11, sintering is performed at a low temperature of about 1000° C. or less.

With the sintering completed, the corresponding constraining body 11 constrains the sheet 2 having the cavity therein, and the filler 20 filled in the cavity 3 constrains the cavity 3, thereby allowing for constrained sintering.

Therefore, the ceramic laminated body 10 and the sheet 2 laminated on the ceramic laminated body 10 can be sintered without undergoing substantially any shrinkage. Of course, in practice, the ceramic laminated body 10 may shrink slightly. The cavity 3 is maintained in its shape without experiencing substantial deformation.

The constraining bodies 11 are not formed to be a part of the substrate but serve to constrain the ceramic laminated body so that the ceramic laminated body can be sintered without shrinkage. Since the constraining bodies 11 and the ceramic laminated body 10 are sintered into one substrate, basically, the constraining bodies 11 may be formed of a material sintered at a temperature higher than the ceramic laminated body 10.

Also, the filler 20 may be formed of a material having sintering characteristics substantially identical to the constraining bodies 11, i.e, being sintered at a temperature substantially identical to or higher than the constraining bodies 11.

This is because the filler 20 having a sintering temperature identical to the ceramic laminated body 10 and the sheet 2 having the cavity therein, respectively can be a part of the substrate. The filler 20 should be removed after sintering.

Also, the sheet 2 having the cavity therein and the ceramic laminated body 10 may be formed of an identical material or different materials. However, the ceramic laminated body 10 and the sheet 2 having the cavity therein may be formed of an identical material or at least very similar material. Also, the ceramic laminated body 10 and the sheet 2 may have an identical or similar sintering temperature.

After sintering is completed as described above, the filler 20 and the constraining bodies 11 are not sintered but evaporate into a condensed state. The constraining bodies 11 and the filler 20 of this state can be removed by sand blast, lapping or ultrasonic waves.

After the sintering is performed and the constraining bodies and filler are removed in the process of FIG. 1E, as shown in FIG. 1F, a ceramic substrate S having the cavity 3 therein is produced.

That is, the corresponding constraining body constrains the sheet 2 having the cavity therein and the filler constrains the cavity, thereby producing the ceramic substrate having the cavity therein without undergoing shrinkage and deformation of the cavity during sintering.

As set forth above, a ceramic laminated substrate manufactured according to an exemplary embodiment of the invention has a cavity formed therein to be manufactured by constrained sintering. Moreover, the ceramic laminated substrate can be manufactured with reliability by constrained sintering due to substantially no deformation of the cavity thereof.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a ceramic laminated substrate, the method comprising:
laminating a sheet having a cavity therein on a ceramic laminated body;
filling the cavity with a predetermined filler; and
laminating and sintering a constraining body on at least one of a top of the sheet having the cavity therein and a bottom of the ceramic laminated body.

2. The method of claim 1, wherein the filler has a sintering temperature substantially equal to or higher than a sintering temperature of the constraining body.

3. The method of claim 1, wherein the filler comprises an alumina slurry.

4. The method of claim 1, further comprising drying the filler, after the filling the cavity with a predetermined filler.

5. The method of claim 1, further comprising removing the filler together with the constraining body, after the sintering.

6. The method of claim 1, wherein the filling the cavity with a predetermined filler comprises:
laminating a screen having a throughhole formed in a position corresponding to the cavity on the sheet having the cavity therein.

7. A method of manufacturing a ceramic laminated substrate, the method comprising:
laminating a sheet having a cavity therein on a ceramic laminated body;
filling the cavity with a first constraining body; and
laminating and sintering a second constraining body on at least one of a top of the sheet having the cavity therein and a bottom of the ceramic laminated body.

8. The method of claim 7, further comprising removing the first and second constraining bodies after the sintering.

9. A ceramic laminated substrate manufactured by the method defined in claim 1.
